(19) United States
(12) Patent Application Publication
(10) Pub. No.: US 2026/0336631 A1
(43) Pub. Date: Oct. 29, 2026

(54) SYSTEM AND METHOD FOR DETECTING WHEEL SLIP

(71) Applicant: Jaguar Land Rover Limited, Coventry, Warwickshire (GB)

(72) Inventors: Meghna LAL, Warwick (GB); Stuart WALKER, Coventry (GB); Tom FRAMPTON, Coventry (GB)

(21) Appl. No.: 19/484,847

(22) PCT Filed: May 14, 2024
(86) PCT No.: PCT/EP2024/063247

§ 371 Date: Nov. 14, 2025

(30) Foreign Application Priority Data
May 17, 2023 (GB) 2307328.1

(51) Int. Cl. B60W 40/068; B60W 10/06; B60W 10/10; B60W 10/18; B60W 10/20

(52) U.S. Cl. CPC B60W 40/068; B60W 10/06; B60W 10/10; B60W 10/18; B60W 10/20; B60W 2520/26; B60W 2520/28

(57) ABSTRACT

Aspects of the present invention relate to a control system for detecting a wheel slip event of a vehicle having a plurality of wheels (W1-W4). The control system includes one or more processors collectively configured to receive a plurality of linear velocity signals (SLC1-SCL4), each of the plurality of linear velocity signals (SLC1-SCL4) indicating a linear velocity of one of the wheels (W1-W4). A dispersion threshold (DTH) is determined for the linear velocities indicated by the plurality of linear velocity signals (SLC1-SCL4). A wheel slip detected signal is output in dependence on a determination that a range (RLV) of the linear velocities is greater than the determined dispersion threshold (DTH). Aspects of the present invention also relate to a system, a vehicle, a method and computer readable instructions.

### TECHNICAL FIELD

The present disclosure relates to a system and method for detecting wheel slip. Aspects of the invention relate to a control system, a system, a vehicle, a method and computer readable instructions.

### BACKGROUND

It is known to provide a road vehicle, such as an automobile, with wheel speed sensors to measure the rotational speed of the wheels. The measured wheel speeds may be used by vehicle control systems, such as an antilock brake system (ABS) or traction control system to control the dynamic operation of the vehicle.

It is an aim of the present invention to address one or more of the disadvantages associated with the prior art.

### SUMMARY OF THE INVENTION

Aspects and embodiments of the invention provide a control system, a system, a vehicle, a method and computer readable instructions as claimed in the appended claims.

According to an aspect of the present invention there is provided a control system for detecting a wheel slip event of a vehicle having a plurality of wheels, the control system comprising one or more processors configured to:
receive a plurality of velocity signals, each of the plurality of velocity signals indicating a velocity of one of the wheels;
determine a dispersion threshold for the velocities of the wheels; and
output a wheel slip detected signal in dependence on a determination that the range of the velocities of the wheels is greater than the determined dispersion threshold. The dispersion threshold may be determined in dependence on the plurality of velocity signals.

The wheel slip detected signal indicates that a wheel slip event has been detected in one or more of the wheels of the vehicle. The wheel slip detected signal can be output to control one or more vehicle subsystems, for example to control dynamic operation of the vehicle.

The velocity signals indicating the velocity may, for example, be received from an anti-lock braking system of the vehicle. The anti-lock braking system typically comprises a plurality of wheel speed sensors for measuring the rotational speed of each of the wheels. A linear velocity parameter of the outside surface of each wheel may be calculated by multiplying the measured rotational speed by a radius of each of the wheels. The linear velocity parameter calculated may be employed as each velocity.

The control system comprises one or more controllers comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon.

The dispersion threshold may be determined in dependence on a dispersion parameter. The dispersion parameter is an arbitrary number and the dispersion threshold may be derived from one or more wheel slip maps (also known as a breakpoint map). The one or more wheel slip maps may be calibrated, for example, for a particular model of vehicle, as well as for different operating conditions of the vehicle or the environment around the vehicle. The dispersion threshold is defined as the value of the dispersion parameter at a particular wheel velocity which, when combined with that wheel velocity, determines a value of a range of wheel velocities that the vehicle may exhibit before a slip event is determined to be occurring. The wheel velocity at which the threshold is set may be the smallest wheel velocity of all the wheels, or the largest velocity of all the wheels or any median value. The dispersion threshold, however, will vary depending on which velocity is set for the map as the particular velocity. In any event, the particular wheel velocity at which the threshold dispersion parameter is employed to determine the presence or absence of a wheel-slip event is based on the measured wheel velocities of the vehicle at that moment of time.

The plurality of wheel slip maps may comprise a first set comprising at least one wheel slip map for selection in dependence on a determination that the vehicle is accelerating. The plurality of wheel slip maps may comprise a second set comprising at least one wheel slip map for selection in dependence on a determination that the vehicle is decelerating.

The wheel slip map may also or instead be selected in dependence on a current driving condition of the vehicle. At least in certain embodiments, the control system is configured to determine the current driving condition of the vehicle.

The driving condition of the vehicle may be determined in dependence on an estimated surface condition, which in turn may be estimated in dependence on a measured ambient temperature. The control system may be configured to receive an ambient temperature signal from a temperature sensor, typically provided onboard the vehicle. The driving condition may be identified as being a low friction operating condition in dependence on a determination that the ambient temperature is in a first range, for example below a first temperature threshold. The driving condition may be identified as being a medium friction operating condition in dependence on a determination that the ambient temperature is in a second range, for example, between first and second temperature thresholds. The driving condition may be identified as being a sand operating condition (i.e., the vehicle is traversing a surface comprising or composed of sand) in dependence on a determination that the ambient temperature is in a second range, for example between first and second temperature thresholds.

The driving condition of the vehicle may be determined in dependence on a measure tyre (tire) pressure. The control system may, for example, differentiate between a high-and a low-tyre pressure driving condition.

The driving condition may, for example, indicate a surface friction expected. At least in certain embodiments, the determined driving condition of the vehicle may be one or more of the following: a low friction driving condition, a medium friction driving condition, a sand (high tyre pressure) driving condition, and a sand (low tyre pressure) driving condition.

The plurality of the wheel slip maps may comprise a first set, for when a determination that the vehicle is accelerating is made, comprising at least one wheel slip map and a second set, for when a determination that the vehicle is decelerating is made, comprising at least one wheel slip map. Corresponding wheel slip maps in the first and second sets may be different from each other. The wheel slip maps in the first and second sets for the same driving condition may be different from each other.

The dispersion threshold at a given wheel velocity in the at least one wheel slip map in the first set may greater than a corresponding dispersion parameter defined in the at least one wheel slip map in the second set. For a given velocity, the dispersion threshold may be smaller when the vehicle is decelerating than when the vehicle is accelerating. The smaller dispersion threshold may provide tighter control limits when the vehicle is decelerating. That is, with a smaller dispersion threshold, a determination of a wheel slip event is more likely to occur and result in consequential adaptation of vehicle sub-systems such as the anti-lock braking or traction control functions.

The dispersion threshold for the one or more wheel slip map is set in dependence on a particular wheel velocity of the vehicle. The control system may be configured to identify a smallest one and/or a largest one of the linear velocities and the particular one of the velocities may be the velocity identified as being the smallest or the largest of the plurality of velocities of the wheels. The dispersion threshold may be a product or a sum of the dispersion parameter derived from the one or more wheel slip map and the particular one of the velocities (or average or median or other calculated value of some or all the wheel velocities). The dispersion parameter may be a dispersion factor, for example as a ratio or a percentage. The dispersion threshold may be determined by multiplying the particular one of the velocities and the dispersion factor. The dispersion parameter may be a dispersion value. The dispersion threshold may be determined by summing the particular one of the linear velocities and the dispersion value.

Where the particular one of the velocities is the velocity identified as being the smallest, the determination that the range of the velocities is sufficiently large to conclude that a wheel slip event is occurring is when the velocity identified as being the largest is greater than the sum of the velocity identified as being the smallest and an amount determined by the dispersion threshold at that velocity.

Similarly, where the particular one of the velocities is the velocity identified as being the largest, the determination that the range of the velocities is sufficiently large to conclude that a wheel slip event is occurring is when the velocity identified as being the smallest is less than the velocity identified as being the largest minus an amount determined by the dispersion threshold at that velocity.

The control system may be configured to generate a surface friction estimate in dependence on detection of a wheel slip event. The control system may be configured to output a surface friction signal indicating the estimated surface friction. The estimated surface friction may be reduced in dependence on the detection of a wheel slip event. For example, the estimated surface friction may be decreased by a predetermined increment or reset to a predetermined value (for example, reset to zero (0)) when a wheel slip event is detected.

Alternatively, or in addition, the estimated surface friction may be increased when the wheel slip event is not detected. For example, the estimated surface friction may be increased by a predetermined increment or reset to a predetermined value (for example, reset to one (1)) when no wheel slip event is detected. The control system may output an updated surface friction periodically.

The surface friction may be estimated in dependence on a combined lateral and longitudinal acceleration of the vehicle when a wheel slip event is detected. The combined lateral and longitudinal acceleration may be calculated as the surface friction value until, either: (i) a lower surface friction is flagged; or (ii) an increase in the surface friction is detected. An increase in the surface friction may, for example, be detected in dependence on one or more of the following: (i) the vehicle achieves a higher level of combined acceleration than the current estimated surface friction would permit; and (ii) a higher level of longitudinal (traction) force is applied than the current estimated surface friction would permit.

The control system may be configured to receive a wheel hop signal indicating that at least one of the wheels of the vehicle is not in contact with the ground. The control system may disregard the surface friction estimation in dependence on receipt of the wheel hop signal.

The control system may be configured to update a current surface friction estimate when the wheel slip event is not detected. The update may, for example, comprise increasing the current surface friction estimate by a predetermined increment. The control system may output a surface friction signal indicating the updated current surface friction estimate.

According to a further aspect of the present invention there is provided a control system for detecting a wheel slip event of a vehicle having a plurality of wheels, the control system comprising one or more processors configured to:
receive a plurality of velocity signals, each of the plurality of velocity signals indicating a rotational speed of one of the wheels;
determine a dispersion threshold; and
output a wheel slip detected signal in dependence on a determination that a range of the rotational speeds is greater than the determined dispersion threshold. The control system can use one or more of the techniques described herein with respect to the velocities of the wheels to detect the wheel slip event. The velocity signals may be rotational speed signals.

According to a further aspect of the present invention there is provided a system comprising the control system described herein and at least one vehicle control unit for controlling at least one vehicle subsystem of the vehicle. The at least one vehicle control unit may be configured to modify the operation of the at least one vehicle subsystem in dependence on receipt of a wheel slip detected signal from the control system.

The at least one vehicle subsystem may comprise one or more of the following: a traction control system, a propulsion (or engine) management system, a transmission system, a steering system, an anti-lock braking system, a suspension system and a differential system. The control or operation of the at least one vehicle subsystem may be changed dynamically in dependence on receipt of a wheel slip detected signal.

The control of the vehicle subsystem in dependence on receipt of the wheel slip detected signal may, for example, comprise one or more of the following:
reducing a throttle response rate;
reducing a power output to a rear axle; and/or
increasing a power output to a front axle.

According to a further aspect of the present invention there is provided a vehicle comprising the system or the control system described herein.

According to a further aspect of the present invention there is provided a method of detecting a wheel slip event of a vehicle having a plurality of wheels, the method comprising:
receiving a plurality of velocity signals, each of the plurality of velocity signals indicating a rotational velocity of a respective one of the wheels;
determining a dispersion threshold; and
outputting a wheel slip detected signal in dependence on a determination that a range of the velocities is greater than the determined dispersion threshold.

The method may comprise estimating a surface friction in dependence on detection of the wheel slip event. The method may comprise outputting a surface friction estimate.

According to a further aspect of the present invention there is provided a computer readable instructions which, when executed by a computer, are arranged to perform a method as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle comprising a control system in accordance with an embodiment of the present invention;

FIG. 2 shows a schematic representation of the vehicle shown in FIG. 1 incorporating the control system;

FIG. 3 shows a block diagram representing the determination of the linear velocity of the wheels of the vehicle;

FIG. 4 shows a schematic representation of the control system in accordance with an embodiment of the present invention;

FIG. 5A shows a graphical representation of a wheel slip map for determining a dispersion threshold when the vehicle is accelerating in a low friction driving condition when the vehicle is accelerating;

FIG. 5B shows a graphical representation of a wheel slip map for determining a dispersion threshold when the vehicle is decelerating in a low friction driving condition; and

FIG. 6 illustrates a method of detecting a wheel slip event and estimating a surface friction.

### DETAILED DESCRIPTION

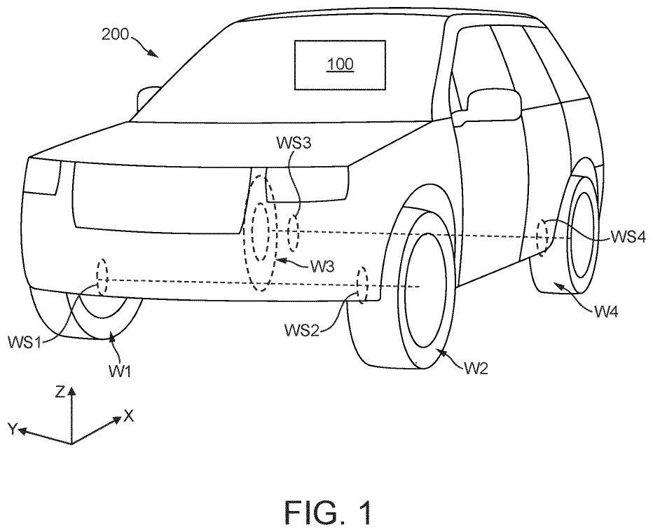

A control system 100 in accordance with an embodiment of the present invention is described herein with reference to the accompanying Figures. As shown in FIG. 1, the control system 100 is installed in a vehicle 200. The vehicle 200 comprises four (4) wheels W1-W4 and, as described herein, the control system 100 is configured to detect a wheel slip event in one or more of the wheels W1-W4. A wheel slip event may occur due to a loss of traction which allows one or more driven wheels W1-W4 of the vehicle 200 to slip and rotate at a different speed to the other wheels. Of course, wheels typically do not rotate at exactly the same speed when cornering, so a marginal difference in speed is not an indication of wheel slip.

The vehicle 200 is described herein with reference to a reference frame comprising a longitudinal axis X, a transverse axis Y and a vertical axis Z. The reference signs herein include a suffix in the form of a whole number to differentiate between a plurality of like components on the vehicle 200. The same suffix is applied for components associated with each other, for example components forming part of the same sub-assembly of the vehicle 200.

The vehicle 200 is a road vehicle, such as an automobile, a sports utility vehicle (SUV) or a utility vehicle. The vehicle 200 comprises one or more torque-generating machine, such as an internal combustion engine (ICE) and/or an electric traction motor. The vehicle 200 may be a battery electric vehicle (BEV), a hybrid electric vehicle (HEV), a plug-in hybrid electric vehicle (PHEV) or an internal combustion engine (ICE) vehicle. The front wheels W1, W2 and/or the rear wheels W3, W4 may be driven by the one or more torque-generating machine.

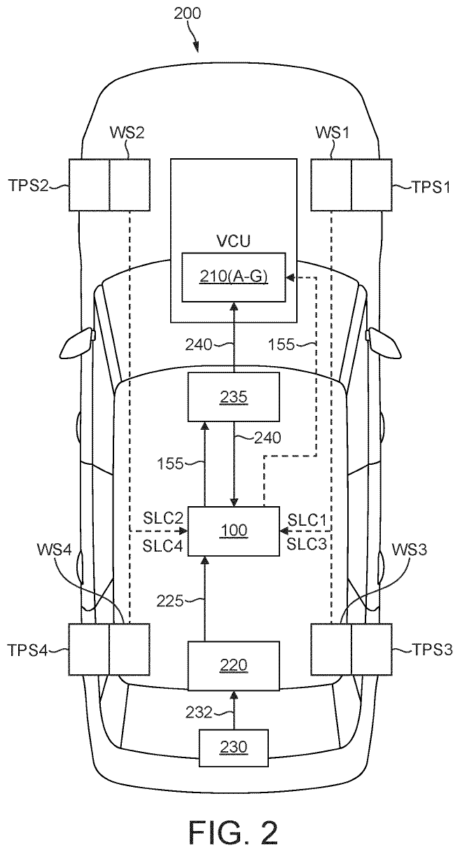

The vehicle 200 comprises a plurality of vehicle subsystems (denoted generally by the reference numeral 210 and shown schematically in FIG. 2). The vehicle subsystems 210 in the present embodiment include, but are not limited to, a traction control system 210A, a propulsion (or engine) management system 210B, a transmission system 210C, a steering system 210D, an anti-lock braking system (ABS) 210E, a suspension system 210F and a differential system 210G. Although six (6) subsystems are illustrated, the vehicle 200 may include additional vehicle subsystems 210. One or more vehicle control unit VCU is provided to control operation of the vehicle subsystems 210. The vehicle control unit VCU may control operation of the vehicle subsystems 210 in dependence on a wheel slip detected signal 155 being received.

The vehicle 200 also comprises a tyre (tire) pressure monitoring system (TPMS) 215 for monitoring the tyre (tire) pressure of each wheel W1-W4. The TPMS 215 comprises a plurality of tyre pressure sensors TPSn. The TPMS 215 is configured to output tyre pressure signals TPS-n indicating the tyre pressure of the tyres (tires) of each of the wheels W1-W4.

The vehicle 200 comprises a driving condition estimator 220. The driving condition estimator 220 is configured to characterise or identify a current driving condition of the vehicle 200. The driving condition estimator 220 outputs a driving condition signal 225 indicating an identified driving condition of the vehicle 200. In the present embodiment, the driving condition estimator 220 is configured to identify the estimated driving condition of the vehicle 200 in dependence on a measured ambient temperature. Accordingly, the vehicle 200 comprises a temperature sensor 230 configured to measure the ambient temperature. The temperature sensor 230 outputs an ambient temperature signal 232 indicating the measured ambient temperature.

The driving condition estimator 220 determines that the driving condition corresponds to a surface:
having a low surface friction in dependence on a determination that the measured ambient temperature is in a first temperature range, for example less than a first temperature threshold (for example, less than 274 Kelvin);
having a medium surface friction in dependence on a determination that the measured ambient temperature is in a second temperature range, for example between first and second temperature thresholds (for example, in the range 274 Kelvin to 300 Kelvin); and
being composed of sand in dependence on a determination that the measured ambient temperature is in a third temperature range, for example greater than a second temperature threshold (for example, greater than 300 Kelvin).

Rather than determine the driving condition in dependence on the ambient temperature, the determination of the driving condition of the vehicle 200 may be determined in dependence on a measured temperature of one or more of the wheels W1-W4.

The driving condition estimator 220 may also be configured to differentiate between the driving conditions in dependence on the measured tyre pressure of one or more of the wheels W1-W4. The driving condition estimator 220 receives the tyre pressure signals TPS-n from the TPMS 215. If the measured tyre pressure of two or more of the wheels W1-W4 is less than a tyre pressure threshold, the driving condition estimator 220 determines that the vehicle 200 is operating in a low tyre pressure mode. If the measured tyre pressure of two or more of the wheels W1-W4 is greater than the tyre pressure threshold, the driving condition estimator 220 determines that the vehicle 200 is operating in a high tyre pressure mode. In the present embodiment, the driving condition estimator 220 utilises the tyre pressure signals TPS-n to differentiate between high and low tyre pressures when the vehicle 200 is operating on the surface composed of sand.

The driving condition estimator 220 may therefore be configured to identify the driving condition as corresponding to one of the following: (i) low surface friction driving condition; (ii) medium surface friction driving condition; (iii) sand (high tyre pressure) driving condition; and (iv) sand (low tyre pressure) driving condition. It will be understood that the driving condition estimator 220 may indicate that the vehicle 200 is operating in a different set of the driving conditions.

The vehicle 200 comprises a surface friction estimation system 235 which is configured to estimate a surface friction (Mu) of a surface on which the vehicle 200 is operating. The surface friction estimation system 235 in the present embodiment is integrated into the control system 100. In a variant, the surface friction estimation system 235 may be separate from the control system 100. The surface friction estimation system 235 is configured to output an estimated surface friction signal 240 which is indicative of the estimated surface friction.

The surface friction estimation system 235 is configured to log the combined lateral and longitudinal acceleration of the vehicle 200 when a wheel slip event is detected. The combined lateral and longitudinal acceleration is then published as a calculated surface friction value, at least until either a lower surface friction is flagged, or evidence is detected that indicates that the surface friction has increased. An increase in the surface friction may be determined in dependence on one or more of the following: (i) the vehicle 200 achieves a higher level of combined acceleration than the current estimated surface friction would permit; and (ii) a higher level of longitudinal force is applied than the current estimated surface friction would permit.

At least one calibratable map may apply a multiplier to the measured combined lateral and longitudinal acceleration. The at least one calibratable map may treat lower values of acceleration as if they were higher. This functionality may help avoid a driver becoming stuck in drive modes associated with a low surface friction. The multiplier increases at a rate dependent on the speed the vehicle 200 after a slip event occurs. In the present embodiment, three (3) calibratable maps are defined to determine the surface friction. The surface friction estimation system 235 is configured to select one of the calibratable maps in dependence on a measured ambient temperature. A first (low) temperature threshold and a second (high) temperature threshold may be defined. A first (cold) calibratable map is selected when the ambient temperature is less than the first temperature threshold. A second (nominal) calibratable map is selected when the ambient temperature is greater than the first temperature threshold and less than the second temperature threshold. A third (hot) calibratable map is selected when the ambient temperature is greater than the second temperature threshold.

The vehicle 200 comprises a body and four wheels W1-W4. In particular, the vehicle 200 comprises first and second front wheels W1, W2 disposed at the front of the vehicle 200; and third and fourth wheels W3, W4 disposed at the rear of the vehicle 200. The vehicle 200 comprises a plurality of wheel speed sensors WS1-WS4. Each of the wheel speed sensors WS1-4 is associated with a respective one of the wheels W1-W4. The wheel speed sensors WS1-WS4 are configured to measure the rotational speed of the wheels W1-W4. The wheel speed sensors WS1-WS4 may be the wheel speed sensors used in the anti-lock brake system 210E. The wheel speed sensors WS1-WS4 are calibrated to output signals SLC1-SCL4 indicating a linear (directional) velocity of each of the wheels W1-W4. The linear velocity is calculated by multiplying the wheel rotational angular speed with a nominal rolling radii of the wheels W1-W4. The output signals SLC1-SCL4 are in the form of linear velocity signals SLC1-SLC4. Each linear velocity signal SLC1-SLC4 is indicative of the linear velocity of a respective one of the wheels W1-4. The linear velocity signals SLC1-SLC4 are output to the control system 100.

In a variant, the rotational speed measured by the wheel speed sensors WS1-WS4 may be output to a controller, for example provided in the anti-lock braking system 210E. The controller may convert the measured rotational speed of each of the wheels W1-W4 to a corresponding linear velocity. In this arrangement, the controller outputs the linear velocity signals SLC1-SLC4.

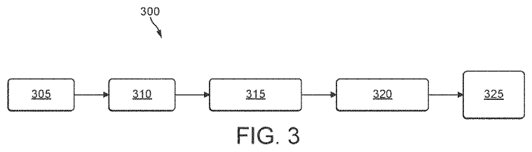

The operation of the wheel speed sensors WS1-WS4 to generate the linear velocity signals SLC1-SLC4 is represented by a block diagram 300 in FIG. 3. The wheel speed sensors WS1-WS4 are associated with each of the wheels W1-W4 (BLOCK 305). The rotational speed is output from the wheel speed sensors WS1-WS4 in the form of a teeth count (BLOCK 310). The rotational velocity of each wheel W1-W4 is equal to the teeth count per unit time (BLOCK 315). The anti-lock braking system (ABS) 210E converts the rotational velocity to the linear velocity (BLOCK 320). The linear velocity signals SLC1-SLC4 are output to the control system 100 (BLOCK 325).

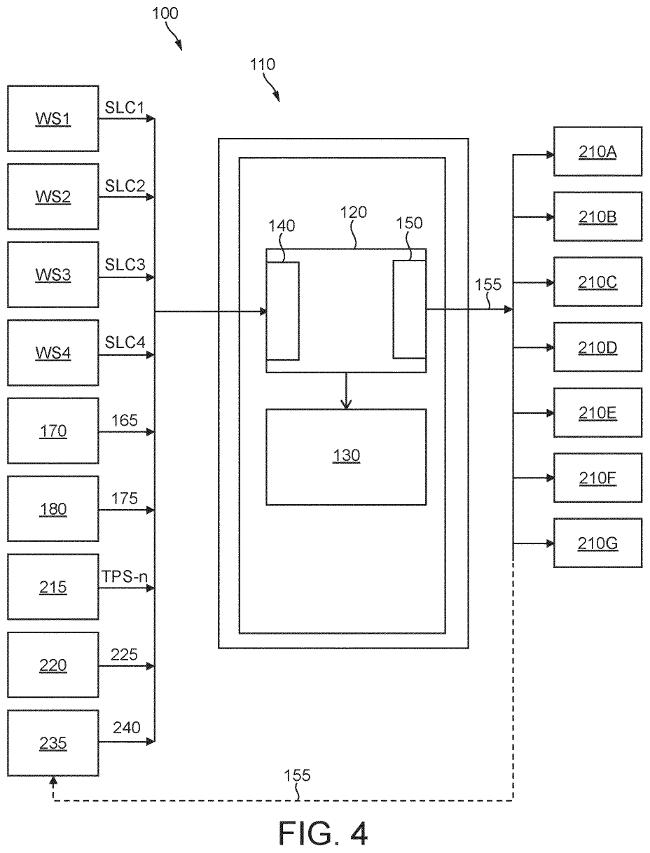

As shown in FIG. 4, the control system 100 comprises one or more controller 110. The control system 100 is configured to receive linear velocity data (denoted generally by the reference numeral 115) from the wheel speed sensors WS1-4 and to determine a linear velocity range RLV of the linear velocity data. The linear velocity range RLV represents a magnitude of the difference between the largest and the smallest of the plurality of linear velocities.

The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 150 of the controller 110. The input 140 is arranged to receive the linear velocity signals SLC1-SLC4 from the wheel speed sensors WS1-WS4. The linear velocity signals SLC1-SLC4 are electrical signals which are indicative of the linear velocity of each of the wheels W1-W4 of the vehicle 200.

The linear velocity range RLV is an absolute value representing the difference between the smallest and largest of the linear velocities. The controller 110 is configured to compare the determined linear velocity range RLV to a dispersion threshold THD. The dispersion threshold THD represents a threshold for the spread of the linear velocities of each of the wheels W1-W4. If the determined linear velocity range RLV is greater than or equal to the dispersion threshold THD, the controller 110 determines that a wheel slip event has occurred. If the determined linear velocity range RLV is less than the dispersion threshold THD, the controller 110 determines that there is not a wheel slip event.

The dispersion threshold THD is a value indicating the maximum difference between the velocities of the wheels that can be considered not to involve a wheel slip. This value varies between operating conditions including the absolute values of the velocities of the wheels. The THD is therefore determined in dependence on one or more wheel slip (breakpoint) maps BPM-n (where the suffix n is an integer greater than or equal to one and applied to identify one of the one or more wheel slip map). The one or more wheel slip maps BPM-n are calibratable. In the present embodiment, the dispersion threshold THD is determined in dependence on a plurality of the wheel slip maps. The wheel slip maps BPM-n are each associated with a respective one of the driving conditions identified by the driving condition estimator 220. A first wheel slip map BPM-1 corresponds to the low surface friction driving condition; a second wheel slip map BPM-2 corresponds to the medium surface friction driving condition; a third first wheel slip map BPM-3 corresponds to the sand (high tyre pressure) driving condition; and a fourth wheel slip map BPM-4 corresponds to the sand (low tyre pressure) driving condition.

In the present embodiment, first and second sets S1, S2 of the wheel slip maps BPM-n are defined. The first and second sets S1, S2 each comprise one each of the first, second, third and fourth wheel slip maps BPM-n. The first and second sets S1, S2 may comprise less than, or more than four wheel slip maps BPM-n. The controller 110 is configured to select one of the wheel slip maps BPM-n from the first set S1 in dependence on a determination that the vehicle 200 is accelerating (i.e., positive acceleration). The controller 110 is configured to select one of the wheel slip maps BPM-n from the second set S2 in dependence on a determination that the vehicle 200 is decelerating (i.e., negative acceleration). The controller 110 receives an acceleration signal 165 from an inertial measurement unit 170 which indicates whether the vehicle 200 is accelerating or decelerating.

Having determined from which set to select a map, the controller 110 is configured to select one of the plurality of wheel slip maps BPM-n in dependence on the driving condition signal 225 received from the driving condition estimator 220.

The wheel slip maps BPM-n each define a relationship between a dispersion parameter DP and linear velocity. The dispersion parameter DP may have units of velocity and be directly relatable to the range of velocities RLV determined from the wheels W1-W4. In this event, the threshold THD is simply the range RLV of values (at a given linear velocity) that the vehicle can exhibit before a wheel slip event is concluded. The threshold varies depending not only on acceleration and deceleration, and driving condition of the vehicle, but also on the absolute value of the given and pre-set linear wheel velocity. The pre-set linear velocity may be the smallest, or largest, linear wheel velocity of the wheels W1-W4, or some figure based on the linear velocities of the wheels W1-W4. Whichever linear wheel velocity is selected as the base velocity in the wheel slip maps BPM-n, the threshold line THD will have a different profile.

Alternatively, the dispersion parameter DP may have units of velocity and be a number that is simply added to the smallest detected linear wheel velocity of the wheels W1-W4. The threshold THD is then a velocity value that must not be exceeded by the largest detected linear wheel velocity of the wheels W1-W4 before a wheel slip event is determined to occur. Similarly, dispersion parameter DP may have units of velocity and be a number that is simply subtracted from the largest detected linear wheel velocity of the wheels W1-W4. The threshold THD is then a velocity value that must not be less than the smallest detected linear wheel velocity of the wheels W1-W4 before a wheel slip event is determined to occur.

Further alternatively, the dispersion parameter DP may be unitless, and be a number that is multiplied by a velocity determined from the linear velocities of the wheels W1-W4 (either the smallest or largest velocity). This determines a velocity value by which the largest detected linear velocity of the wheels must not exceed (if based on the smallest velocity), or a velocity value by which the smallest detected linear velocity of the wheels must not be less than (if based on the largest velocity).

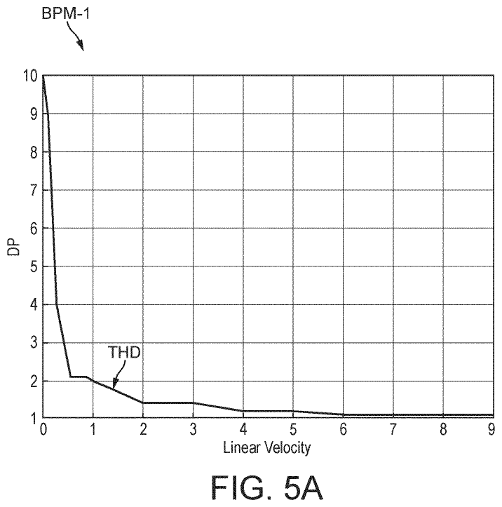

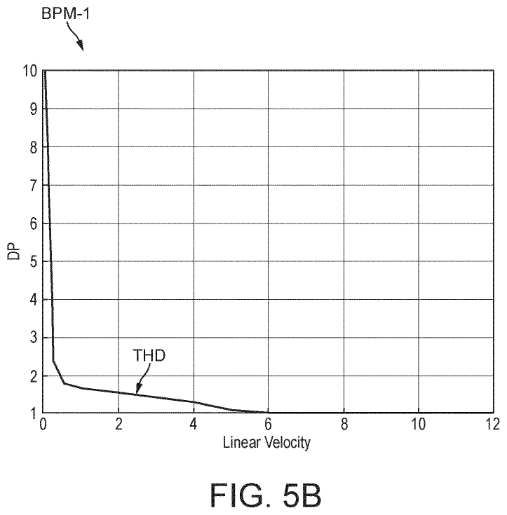

In one embodiment, each of the wheel slip maps BPM-n defines the relationship between the dispersion parameter DP and the smallest one of the linear velocities of the wheels W1-W4. A graphical representation of a first wheel slip map BPM-1 selected from the first set S1 when the vehicle 200 is accelerating is shown in FIG. 5A by way of example. A graphical representation of a first wheel slip map BPM-1 selected from the second set S2 when the vehicle 200 is decelerating is shown in FIG. 5B by way of example. The variants of the wheel slip maps BPM-n selected when the vehicle is accelerating or decelerating are different from each other, as represented by the different plots shown in FIGS. 5A and 5B. The linear velocity is represented on the X-axis and the dispersion parameter DP is represented on the Y-axis. The first wheel slip map BPM-1 may be defined as a look-up table which is stored in the one or more memory device 130. The curve in FIGS. 5A and 5B represents the dispersion threshold at different linear velocities. The controller 10 is configured to access the look-up table to determine the dispersion threshold at a particular linear velocity. In a variant, the controller 10 may be configured to implement an algorithm to determine the dispersion threshold at a particular linear velocity.

In the wheel slip maps BPM-n, the dispersion parameter DP is simply a number (as is the representation of linear velocity). The threshold line (THD) is empirically determined and represents the dispersion parameter (at that speed) at which wheel slip may occur if the range RLV of wheel velocities is greater than an amount determined by the dispersion parameter and the particular velocity. That is, by multiplying the dispersion parameter by the linear velocity, a quantum or range of possible linear velocity is generated; this is the dispersion threshold THD. For example, at the linear velocity 1, the dispersion parameter at the threshold line THD is 2, meaning that the threshold range of acceptable linear velocities is: 2 multiplied by 1, equal to 2. Thus it can be seen that at low velocities, the DP value at the threshold THD is relatively high, whereas at higher speeds it is relatively low, whereby a similar, but not necessarily equal, threshold range is achieved at all velocities. (Alternatively, to reach a threshold value of the range of acceptable linear velocities it may instead be the sum of the dispersion parameter (which in this case is in units of velocity) and linear velocity, that is it may be 2 added to 1, equal to 3).

The controller 110 is configured to compare the determined linear velocity range RLV (i.e., the difference between the smallest and the largest of the linear velocities) to the quantum generated at the dispersion threshold THD and the relevant linear velocity. If the determined linear velocity range RLV is greater than or equal to that quantum, the controller 110 determines that a wheel slip event has occurred. The controller 110 outputs a wheel slip detected signal 155 to indicate the detection of the wheel slip event. If the determined linear velocity range RLV is less than the dispersion threshold THD quantum, the controller 110 determines that a wheel slip event has not occurred. The output 150 may be arranged to output a signal to indicate that a wheel slip event is not detected. Alternatively, an absence of the wheel slip detected signal 155 may indicate that a wheel slip event is not detected.

The dispersion threshold THD may optionally be determined on the basis of the smallest one of the linear velocities of the wheels W1-W4. In particular, the controller 110 may be configured to determine the dispersion threshold THD by adding the dispersion parameter DP accessed from the wheel slip map BPM-n at the linear velocity of the smallest one of the linear velocities of the wheels W1-W4. If the largest one of the linear velocities is greater than the dispersion threshold THD, the controller 110 determines that a wheel slip event has occurred. The controller 110 outputs the wheel slip detected signal 155 to indicate the detection of the wheel slip event. The controller 110 may be configured to identify the one or more of the wheels W1-W4 which is experiencing the wheel slip event, that is which wheel or wheels are responsible for the range RLV exceeding the determined threshold. The wheel slip detected signal 155 may comprise an indication of the one or more of the wheels W1-W4 that is determined to be experiencing the wheel slip event.

In a variant, the dispersion threshold THD may be determined in dependence on the largest one of the linear velocities of the wheels W1-W4. In particular, the controller 110 may be configured to determine whether the dispersion threshold THD is exceeded (and a wheel slip detected) by subtracting, from the dispersion parameter threshold value accessed from the wheel slip map BPM-n at the largest one of the linear velocities of the wheels W1-W4, the linear velocity range RLV. If the smallest one of the linear velocities of the wheels W1-W4 is less than dispersion threshold THD the controller 110 determines that a wheel slip event has occurred. Likewise, the controller 110 outputs the wheel slip detected signal 155 to indicate the detection of the wheel slip event and the controller 110 may be configured to identify the one or more of the wheels W1-W4 which is experiencing the wheel slip event.

In a further variant, the dispersion parameter DP may be a dispersion factor. The dispersion factor may comprise a fractional component. The dispersion threshold THD may be determined by multiplying the smallest one of the linear velocities by the dispersion factor. The dispersion parameter DP in this arrangement is greater than one (1). The controller 110 compares the determined dispersion threshold THD to the largest one of the linear velocities of the wheels W1-W4. If the largest one of the linear velocities is greater than the dispersion threshold THD, the controller 110 determines that the linear velocity range RLV is greater than the dispersion threshold THD and identifies a wheel slip event. Alternatively, the dispersion threshold THD may be determined by multiplying the largest one of the linear velocities by the dispersion factor. The dispersion parameter DP in this event is less than one (1). The controller 110 compares the determined dispersion threshold THD to the smallest one of the linear velocities of the wheels W1-W4. If the smallest one of the linear velocities is less than the dispersion threshold THD, the controller 110 determines that the linear velocity range RLV is greater than the dispersion threshold THD and identifies a wheel slip event. The controller 110 outputs the wheel slip detected signal 155 to indicate the detection of the wheel slip event.

As outlined above, the surface friction estimation system 235 is provided to estimate the surface friction of the surface on which the vehicle 200 is operating. The wheel slip detected signal 155 is output to the surface friction estimation system 235. The surface friction estimation system 235 is configured to estimate the surface friction in dependence on the detection of the wheel slip event. The estimated surface friction is reduced by a predetermined amount in dependence on the detection of a wheel slip event. The estimated surface friction is increased when the wheel slip event is not detected. For example, the estimated surface friction may be increased by a predetermined increment or reset to a predetermined value (for example, reset to one (1)) when no wheel slip event is detected. An updated surface friction estimate is then output. The surface friction estimation system 235 outputs the estimated surface friction signal 240 to the control system 100. Alternatively, or in addition, the surface friction estimation system 235 outputs the estimated surface friction signal 240 to one or more of the vehicle subsystems 210.

The control system 100 may be configured to receive a wheel hop signal 175 from a wheel hop detection unit 180. The wheel hop signal 175 provides an indication that one or more of the wheels W1-W4 of the vehicle 200 is not in contact with the ground. The control system 100 may disregard the surface friction estimation in dependence on receipt of the wheel hop signal 175. The wheel hop detection unit 180 may detect a wheel hop event in dependence on a measured acceleration of the vehicle 200, for example in dependence on an acceleration signal 165 received from the inertial measurement unit 170. The wheel hop detection unit 180 is illustrated in FIG. 4 as being separate from the control system 100. In a variant, the wheel hop detection unit 180 may be incorporated into the control system 100.

One or more of the vehicle subsystems 210 may be controlled in dependence on the surface friction estimate. In dependence on the surface friction estimate, the control system 100 may modify or adapt one or more of the following: the traction control system 210A, the propulsion (or engine) management system 210B, the transmission system 210C, the steering system 210D, the anti-lock braking system (ABS) 210E, the suspension system 210F and the differential system 210G.

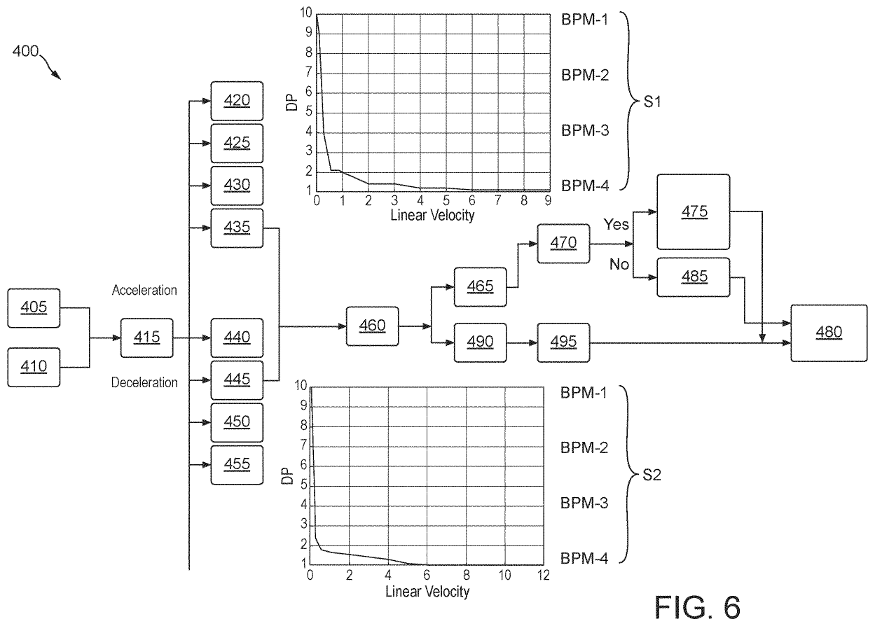

FIG. 6 illustrates a method 400 according to an embodiment of the invention. The method 400 is a method of detecting a wheel slip event in one or more wheel W1-W4 of a vehicle 200, such as the vehicle 200 illustrated in FIG. 1. The method 400 may be performed by the control system 100 illustrated in FIG. 1. In particular, the memory device 130 may comprise computer-readable instructions which, when executed by the processor 120, perform the method 400 according to an embodiment of the invention. The method 400 will now be described with reference to FIG. 6.

The linear velocities of each of the wheels W1-W4 are determined. A smallest one of the linear velocities is identified (BLOCK 405); and a largest one of the linear velocities is identified (BLOCK 410). A difference between the smallest and the largest of the linear velocities is determined (BLOCK 415). The difference between the smallest and the largest of the linear velocities represents the range of the linear velocities. A determination is made if the vehicle 200 is accelerating or decelerating.

A wheel slip map BPM-n is selected from the first set S1 in dependence on a determination that the vehicle 200 is accelerating. The first set S1 comprises the first, second, third and fourth wheel slip maps BPM-1 to BPM-4. One of the wheel slip maps BPM-n is selected in dependence on the determined driving condition of the vehicle 200. The first wheel slip map BPM-1 is selected in dependence on a determination that the vehicle 200 is in the low surface friction driving condition (BLOCK 420). The second wheel slip map BPM-2 is selected in dependence on a determination that the vehicle 200 is in the medium surface friction driving condition (BLOCK 425). The third wheel slip map BPM-3 is selected in dependence on a determination that the vehicle 200 is in the sand (high tyre pressure) driving condition (BLOCK 430). The fourth wheel slip map BPM-4 is selected in dependence on a determination that the vehicle 200 is in the sand (low tyre pressure) driving condition (BLOCK 435). The dispersion threshold THD is determined in dependence on the selected one of the wheel slip maps BPM-n.

A wheel slip map BPM-n is selected from the second set S2 in dependence on a determination that the vehicle 200 is decelerating. The second set S2 also comprises first, second, third and fourth wheel slip maps BPM-1 to BPM-4 (which are likely different from the slip maps BPM-1 to BPM-4 of the first set S1). One of the wheel slip maps BPM-n is selected in dependence on the determined driving condition of the vehicle 200. The first wheel slip map BPM-1 is selected in dependence on a determination that the vehicle 200 is in the low surface friction driving condition (BLOCK 440). The second wheel slip map BPM-2 is selected in dependence on a determination that the vehicle 200 is in the medium surface friction driving condition (BLOCK 445). The third wheel slip map BPM-3 is selected in dependence on a determination that the vehicle 200 is in the sand (high tyre pressure) driving condition (BLOCK 450). The fourth wheel slip map BPM-4 is selected in dependence on a determination that the vehicle 200 is in the sand (low tyre pressure) driving condition (BLOCK 455). The dispersion threshold THD is determined in dependence on the selected one of the wheel slip maps BPM-n.

The difference between the smallest and the largest of the linear velocities is compared to the determined dispersion threshold THD (BLOCK 460). The linear velocity at which the comparison is made on the selected wheel slip map BPM-n depends on whether the map has been constructed based on a comparison with the smallest one, or the largest one or an average one of the linear velocities of the wheels W1-W4. If the difference between the smallest and the largest of the linear velocities is greater than the determined dispersion threshold THD at the relevant linear velocity, a wheel slip event is detected (BLOCK 465). A check is performed to determine if there is a wheel hop event where one of the wheels W1-W4 of the vehicle 200 hops off the ground (BLOCK 470). If a wheel hop event is detected, a surface friction estimation is set to false since the estimation will be inaccurate during a wheel hop event (BLOCK 475). A surface friction estimation is output (BLOCK 480). If a wheel hop event is not detected, a combined acceleration is logged as a new friction estimation (BLOCK 485). The surface friction estimation is output (BLOCK 480). If the comparison (BLOCK 460) determines that the difference between the smallest and the largest of the linear velocities is less than the determined dispersion threshold THD at the relevant linear velocity, no wheel slip event is detected (BLOCK 490). The surface friction estimation is increased and/or set to one (1) (BLOCK 495). The updated surface friction estimation is output (BLOCK 480).

In summary, the dispersion parameter discussed herein is a number that represents a value of the difference between the fastest and slowest wheel on the vehicle. The range RLV measured could itself be plotted on any of the slip maps, and the line in the graphs represents the maximum value, at different speeds, that the range RLV can have before it is concluded that there is a wheel slip. How this range is represented in the graphs/slip maps, and the value of the threshold, is arbitrary and depends on how value is employed to determine if there is a wheel slip.

The range RLV of speeds of the wheels can be different, depending on the overall speeds of the wheels, before it is concluded that there is a wheel slip. For example, there is always a difference in speeds during cornering of a vehicle, because the outside wheels follow a longer path than the inside wheels. Furthermore, there may be a different difference of speed, without wheel slip being concluded, depending on speed. Whether it is the speed of the fastest or the slowest wheel at which a threshold difference is applied is not significant, other than that there is a slightly larger number that would be subtracted from a highest speed than would be added to a lowest speed. By way of example, if the slowest and fastest wheels are at 100 and 105 speeds per second (however the speed is measured and employed by the control system) and are not deemed to be slipping, if the lowest speed wheel was instead 99, then, at that speed, with the fastest wheel at 105, a wheel slip may be determined to exist. On the other hand, if the fastest wheel is 106, and the slowest wheel 100, there may not yet be slip. That is, the system has an addition threshold of 7 for a lowest speed base at 100, or subtraction threshold of 6 for a highest speed base at 105, in order to conclude a wheel slip. (These numbers are purely exemplary and a converse relationship may be determined between threshold and speed.) Similarly, some middle speed, a median or average value of the wheel speeds, could be used as the base for setting an acceptable range that does not indicate a wheel slip. In the example just discussed, that threshold could be somewhere between the threshold range when added to the lowest speed, or subtracted from the highest speed. In this example, the average speed may be 102.5, which could set a value of 6.5 for the threshold range between upper and lower speeds.

The graph of the threshold therefore has a different shape against linear velocity if the plot is of:
a unitless factor that is multiplied by:
   the highest wheel speed;
   the lowest wheel speed; or
   some intermediate value;
      to give a value of a range of speeds that cannot be exceeded by the measured range RLV; or
a value with units of speed that is:
   added to the lowest speed and compared with the highest speed; or
   subtracted from the highest speed and compared with the lowest, or
   simply compared against the difference between the highest and lowest speeds.

The determination of a wheel slip should of course be independent of the method of calculating it. Therefore the threshold line in the graphs have different shapes depending on the method which is used to determine whether the threshold is exceeded. The shape of the graphs illustrated in FIGS. 5A and 5B may be based on the dispersion parameters being multiplication factors. That is, at low speeds, the factor of the dispersion parameter DP when multiplied by a low speed is high, in order to generate a range of differences that can exist even at low speeds without slip. Whereas, the factor to be multiplied by a high speed is smaller in order to generate a small range (albeit a possibly larger range than at low speeds) not to be exceeded by the measured range RLV in order to determine that there is no wheel slip.

However, the shape of the corresponding threshold lines THD in graphs (not shown) where the dispersion parameter is a velocity value to be added to (or subtracted from) a particular measured (or calculated) velocity would be rather different in form to those of FIGS. 5A and 5B. The threshold line THD would be somewhat horizontal.

It will be appreciated that various changes and modifications can be made to the present invention without departing from the scope of the present application. The control system 100 has been described herein with respect to linear velocities which are positive (+ve), i.e. indicating that the vehicle 100 is travelling forwards. The system and method(s) described herein are also applicable with respect to linear velocities which are negative (−ve), i.e. indicating that the vehicle 100 is travelling in reverse. The control system 100 and method may, for example, operate with respect to a magnitude of the or each linear velocity. Other approaches to account for linear velocities which are positive or negative are also envisaged.

1. A control system for detecting a wheel slip event of a vehicle having a plurality of wheels, the control system comprising one or more processors configured to:
receive a plurality of velocity signals, each of the plurality of velocity signals indicating a velocity of one of the wheels;
determine a dispersion threshold for the velocities of the wheels in dependence on the plurality of velocity signals; and
output a wheel slip detected signal in dependence on a determination that a range of the velocities of the wheels is greater than the determined dispersion threshold.

2. The control system of claim 1, wherein the dispersion threshold is determined in dependence on a dispersion parameter, the dispersion parameter being determined in dependence on one or more wheel slip map.

3. The control system of claim 2, wherein the dispersion parameter is derived from a selected one of a plurality of the wheel slip maps, the wheel slip map being selected in dependence on a current driving condition of the vehicle and/or a dynamic operating parameter of the vehicle.

4. he control system of claim 3, wherein the plurality of wheel slip maps comprise a first set comprising at least one wheel slip map and a second set comprising at least one wheel slip map;
wherein the control system is configured to select the at least one wheel slip map from the first set in dependence on a determination that the vehicle is accelerating, and to select the at least one wheel slip map from the second set in dependence on a determination that the vehicle is decelerating.

5. The control system of claim 4, wherein the dispersion threshold defined in the at least one wheel slip map in the first set is greater than a corresponding dispersion threshold defined in the at least one wheel slip map in the second set.

6. The control system of claim 2, wherein the dispersion threshold is derived from the one or more wheel slip map in dependence on a selected one of the velocities of the wheels; and
the dispersion threshold is a product of the dispersion parameter derived from the one or more wheel slip map and the selected one of the velocities.

7. The control system of claim 6, wherein the selected one of the velocities is the velocity identified as being the smallest, and the determination that the range of the velocities is sufficiently large to conclude that a wheel slip event is occurring is when the velocity identified as being the largest is greater than a sum of the velocity identified as being the smallest and the dispersion threshold at that velocity; or
wherein the selected one of the velocities is the velocity identified as being the largest, and the determination that the range of the velocities is sufficiently large to conclude that a wheel slip event is occurring is when the velocity identified as being the smallest is less than the velocity identified as being the largest minus the dispersion threshold at that velocity.

8. The control system of claim 1, wherein the velocity signal is a linear velocity signal indicating a linear velocity of the wheels and determined by multiplying a rotational velocity measured at the wheels by a factor comprising a radius of the wheel.

9. The control system of claim 1, wherein the control system is configured to:
generate a surface friction estimate in dependence on detection of the wheel slip event; and
output a surface friction signal indicating the estimated surface friction estimate.

10. The control system of claim 9, wherein the control system is configured to receive a wheel hop signal indicating that at least one of the wheels of the vehicle is not in contact with the ground; and
to disregard the surface friction estimation in dependence on receipt of the wheel hop signal.

11. The control system of claim 1, wherein the control system is configured to:
update a current surface friction estimate when the wheel slip event is not detected, the update comprising increasing the current surface friction estimate by a predetermined increment; and
output a surface friction signal indicating the updated current surface friction estimate.

12. A system comprising the control system of claim 1 and at least one vehicle control unit for controlling at least one vehicle subsystem of the vehicle, the at least one vehicle control unit being configured to modify the operation of the at least one vehicle subsystem in dependence on receipt of the wheel slip detected signal from the control system.

13. A vehicle comprising the system of claim 12 or the control system of claim 1.

14. A method of detecting a wheel slip event of a vehicle having a plurality of wheels, the method comprising:
receiving a plurality of velocity signals, each of the plurality of velocity signals indicating a velocity of one of the wheels;
determining a dispersion threshold; and
outputting a wheel slip detected signal in dependence on a determination that a range of the velocities is greater than the determined dispersion threshold.

15. Computer readable instructions which, when executed by a computer, are arranged to perform a method according to claim 14.
